(19) United States
(12) Patent Application Publication
(10) Pub. No.: US 2014/0206529 A1
(43) Pub. Date: Jul. 24, 2014

(54) APPARATUS AND METHOD FOR MANUFACTURING SILICA-TITANIA CATALYST

(71) Applicant: KOREA INSTITUTE OF SCIENCE AND TECHNOLOGY, Seoul (KR)

(72) Inventors: Jongsoo JURNG, Seoul (KR); Sung Min CHIN, Uijeongbu-si (KR); Eun-seuk PARK, Seongnam-si (KR); Min-su KIM, Jeonju-si (KR)

(21) Appl. No.: 13/914,863

(22) Filed: Jun. 11, 2013

(30) Foreign Application Priority Data
Jan. 24, 2013 (KR) 10-2013-0008150

(51) Int. Cl. B01J 37/14; B01J 12/02

(52) U.S. Cl. CPC B01J 37/14; B01J 12/02
USPC 502/242; 422/187

(57) ABSTRACT

Provided are an apparatus and method for preparing a silica-titania catalyst. The apparatus for preparing a silica-titania catalyst, comprising: precursor supplying units; an oxygen supplying line; a reaction unit; and a recovering unit, wherein the precursor supplying units vaporize a silica precursor and titania precursor and supply them to the reaction unit, wherein the oxygen supplying line supplies an oxygen source to the reaction unit, wherein the reaction unit converts vaporizates of the silica precursor and titania precursor supplied from the precursor supplying units to produce a silica-titania catalyst, wherein the recovering unit cools, condenses and collects the silica-titania catalyst produced at the reaction unit, wherein the recovering unit comprises a cooler for cooling the silica-titania catalyst introduced from the reaction unit, and the cooler comprises a turbulence-forming section on a flow path of the silica-titania catalyst.

### CROSS-REFERENCE TO RELATED APPLICATION

This application claims priority to Korean Patent Application No. 10-2013-0008150, filed on 2013 Jan. 24, and all the benefits accruing therefrom under 35 U.S.C. §119, the contents of which in its entirety are herein incorporated by reference.

### BACKGROUND

1. Field

The present disclosure relates to a novel apparatus and method for preparing a silica-titania (SiO₂—TiO₂) catalyst.

2. Description of the Related Art

Although industrial development has provided human life with a lot of advantages and benefits, it causes a problem of environmental pollution. In addition, emission of contaminants has increased. Among various toxic contaminants, nitrogen oxides emitted into the air particularly have become a main cause of acid rain and downtown smog, and have shown significant social impact. As a part of solutions therefor, many attempts have been made continuously to decompose various contaminants by irradiating light as an ecofriendly energy source to photocatalysts.

Photocatalysts have excellent mechanical, electrical, electronic and chemical properties as compared to other materials. Thus, photocatalysts have been given many attentions in various industrial fields including functional materials and environment. Active studies have also been conducted about such photocatalysts.

In addition, nano-sized ultrafine particles having a photocatalyst particle size of several nanometers or less have been used as advanced materials. Nanoparticles having such a small particle size have an increased surface area per unit weight as compared to general fine powder. Such an increased surface area results in an increase in activity of a catalyst and sensitivity of a sensor.

A typical photocatalyst, titania (TiO₂), has a high refraction index and excellent scientific properties, such as whiteness, masking ability and coloring ability, high chemical stability and high resistance against UV rays. Thus, TiO₂ occupies approximately 80% of the white-colored materials used in the world currently. In addition, it has been studied recently as a photocatalyst capable of photolysis of toxic contaminants with ease in the field of environmental industry. Further, TiO₂ has no light-corrosive property, is not biologically and chemically harmful, and has no effect upon the human body. It also has excellent stability against acid, base and organic solvents. Therefore, many studies have been conducted about methods of removing organic contaminants effectively by using TiO₂ and of improving photocatalytic quality of TiO₂.

However, TiO₂ nanaoparticles are not stable thermally, and thus undergo a phase transition and sintering with ease at high temperature, resulting in a significant decrease in specific surface area. Such phase transition characteristics of TiO₂ nanoparticles are important in terms of their application. It is required that the disadvantage of TiO₂ nanoparticles at high temperature is solved in order to extend the spectrum of applications of TiO₂ nanoparticles to high temperature environment.

To solve the disadvantage of phase transition at high temperature, many studies have been conducted about composite particles of TiO₂ particles with other particles, including Al₂O₃, ZrO₂, CdS, CdSe, ZnO, SnO₂, PbS, WO₃ or SiO₂. Particularly, when silica (SiO₂) is added to TiO₂, it is possible to improve thermal stability. Therefore, active studies have been conducted about the combination of SiO₂ with TiO₂. For example, the related art is disclosed in Korean Patent Application Publication No. 10-2007-0122453, Korean Patent No. 10-1090100 and Japanese Patent No. 4108926.

Meanwhile, catalysts, such as SiO₂—TiO₂ have been prepared by a wet process, such as a sol-gel process. However, such a process shows a limitation in composition of the catalyst to be produced, and has difficulty in preparing a high-purity homogeneous catalyst. Further, such a process requires a relatively large number of operations, including dissolution, evaporation, drying, pulverization and firing. Thus, it takes a long time of several days or more to prepare a catalyst by such a process. In addition, during the preparation of a catalyst, the catalyst may undergo degradation of surface area and dispersibility. Therefore, the process is not commercially applicable.

Further, such a catalyst has also been prepared through combustion or flame treatment. However, in this case, it is difficult to control temperature and to prepare a nanometer-sized catalyst having a uniform particle size. Moreover, a complicated process is required in this case.

### SUMMARY

The present disclosure is directed to providing an apparatus and method for preparing a silica-titania (SiO₂—TiO₂) catalyst having a high specific surface area, uniform nanoparticle size and excellent thermal stability by a simple process through chemical vapor condensation.

In one aspect, there is provided an apparatus for preparing a silica-titania catalyst, comprising:

precursor supplying units;

an oxygen supplying line;

a reaction unit; and

a recovering unit,

wherein the precursor supplying units vaporize a silica precursor and titania precursor and supply them to the reaction unit,

wherein the oxygen supplying line supplies an oxygen source to the reaction unit,

wherein the reaction unit converts vaporizates of the silica precursor and titania precursor supplied from the precursor supplying units to produce a silica-titania catalyst,

wherein the recovering unit cools, condenses and collects the silica-titania catalyst produced at the reaction unit,

wherein the recovering unit comprises a cooler for cooling the silica-titania catalyst introduced from the reaction unit, and the cooler comprises a turbulence-forming section on a flow path of the silica-titania catalyst.

According to an embodiment, the cooler may comprise an external tube and an internal tube formed in the external tube, and a coolant flow path may be formed between the internal tube and the external tube. The internal tube may comprise a flow path through which the silica-titania catalyst passes, and the flow path may comprise a turbulence-forming section against which the silica-titania catalyst introduced to the flow path bumps to form turbulence.

According to another embodiment, the precursor supplying units may comprise a silica precursor supplying unit and a titania precursor supplying unit. In addition, each precursor supplying unit may comprise a vaporization tank in which each precursor is heated and vaporized, a precursor supplying line through which the precursor vaporized at the vaporization tank is conveyed and supplied to the reaction unit, and a carrier gas supplying line through which a carrier gas is supplied to the vaporization tank.

According to still another embodiment, the vaporization tank may comprise a bubbler in which the precursors are received and vaporized, and an oil bath applying heat to the bubbler. According to yet another embodiment, the precursor supplying line may be provided with a constant temperature-maintaining member preventing condensation of the precursors.

According to the apparatus and method disclosed herein, it is possible to obtain a silica-titania (SiO₂—TiO₂) catalyst having a high specific surface area, uniform nanoparticle size and excellent thermal stability with ease by a simple process through chemical vapor condensation.

### BRIEF DESCRIPTION OF THE DRAWINGS

The above and other aspects, features and advantages of the disclosed exemplary embodiments will be more apparent from the following detailed description taken in conjunction with the accompanying drawings in which:

FIG. 1 is a schematic view illustrating an apparatus for preparing a silica-titania (SiO₂—TiO₂) catalyst in accordance with an embodiment;

FIG. 2 is a schematic sectional view illustrating a particular embodiment of a cooler forming an apparatus for preparing a silica-titania (SiO₂—TiO₂) catalyst in accordance with an embodiment;

FIG. 3 is a transmission electron microscopy (TEM) image of the silica-titania (SiO₂—TiO₂) catalyst and titania catalyst obtained according to an Example and Comparative Example;

FIG. 4 is a TEM image of the silica-titania (SiO₂—TiO₂) catalyst and titania catalyst obtained according to an Example and Comparative Example, after heat treatment at 900° C.;

FIG. 5 is a graph illustrating the results of X-ray diffractometry (XRD) of the silica-titania (SiO₂—TiO₂) catalyst and titania catalyst obtained according to an Example and Comparative Example;

FIG. 6 is a graph illustrating the results of XRD of the silica-titania (SiO₂—TiO₂) catalyst and titania catalyst obtained according to an Example and Comparative Example, after heat treatment at 900° C.; and

FIG. 7 shows the results of elemental analysis of the silica-titania (SiO₂—TiO₂) catalyst obtained according to an embodiment using energy dispersive spectrometry (EDS).

<Detailed Description of Main Elements>

| | |
|---|---|
| 100, 100′: precursor supplying units | 120: vaporization tank |
| 140: precursor supplying line | 160: carrier gas supplying line |
| 200: oxygen supplying line | 300: reaction unit |
| 310: reaction tube | 320: heat supplying member |
| 400: recovering unit | 410: cooler |
| 412: external tube | 414: internal tube |
| 414a: turbulence-forming section | |

### DETAILED DESCRIPTION

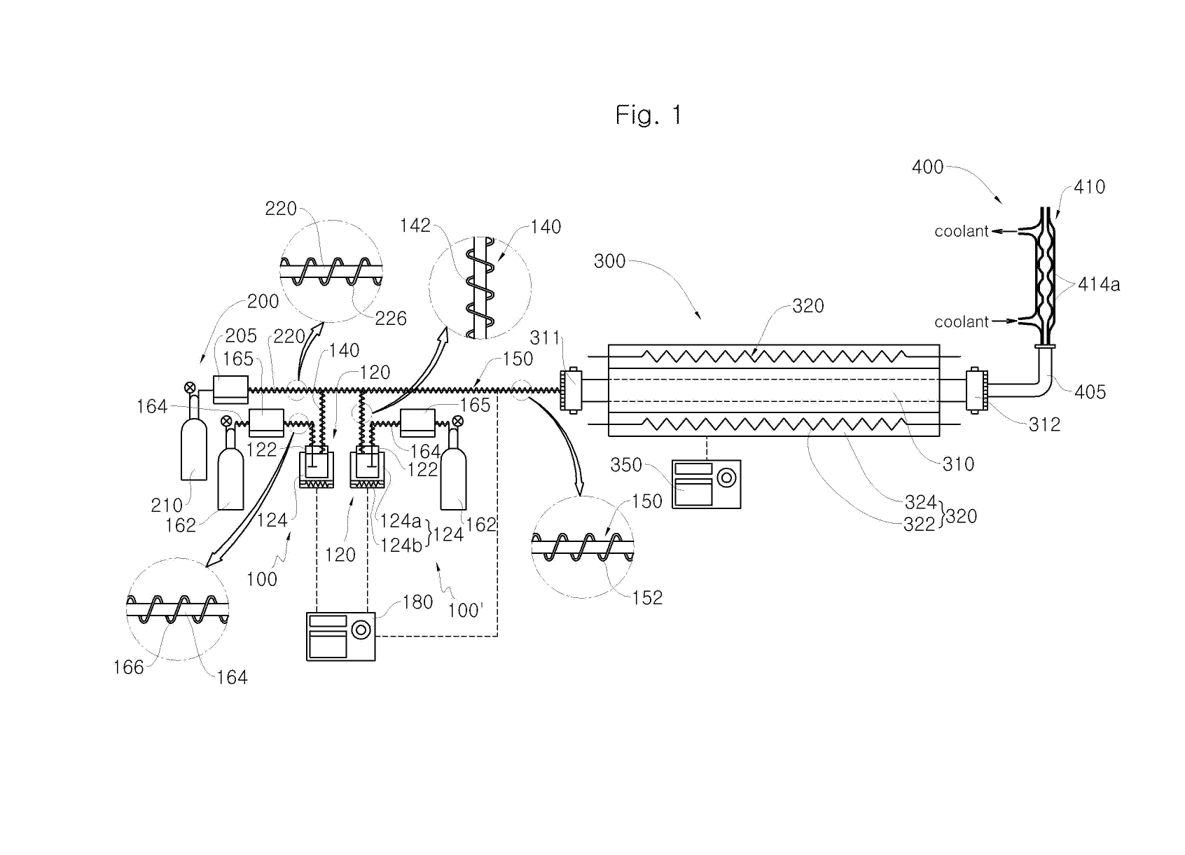

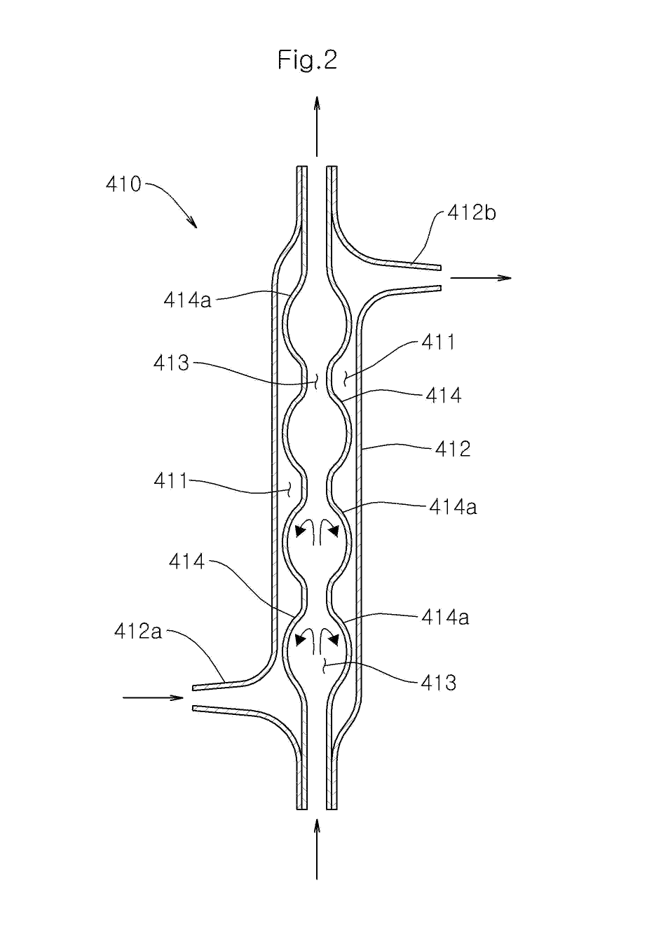

Exemplary embodiments now will be described more fully hereinafter with reference to the accompanying drawings, in which exemplary embodiments are shown. FIG. 1 is a schematic view illustrating an apparatus for preparing a silica-titania (SiO₂—TiO₂) catalyst in accordance with an embodiment, and FIG. 2 is a schematic sectional view illustrating a particular embodiment of a cooler 410 forming an apparatus for preparing a silica-titania (SiO₂—TiO₂) catalyst in accordance with an embodiment.

Referring to FIG. 1, the apparatus for preparing a silica-titania (SiO₂—TiO₂) catalyst, comprises: precursor supplying units 100, 100′ in which a silica precursor and titania precursor are allowed to vaporize and supplied to a reaction unit 300; an oxygen supplying line 200 through which an oxygen source is supplied to a reaction unit 300; a reaction unit 300 in which vaporizates of the silica precursor and titania precursor supplied from the precursor supplying units 100, 100′ are converted to produce a silica-titania (SiO₂—TiO₂) catalyst; and a recovering unit 400 in which the silica-titania (SiO₂—TiO₂) catalyst produced at the reaction unit 300 are cooled, condensed and collected.

The precursor supplying units 100, 100′ are not particularly limited, as long as they allow a silica precursor and titania precursor to be vaporized so as to be supplied to the reaction unit 300. In other words, in the precursor supplying units 100, 100′, vaporizate of the silica precursor and that of titania precursor are produced, and then are conveyed and supplied to the reaction unit 300.

According to an embodiment, the precursor supplying units 100, 100′ allow the silica precursor and titania precursor to be vaporized (evaporated) in one vaporization tank 120 so that they are supplied to the reaction unit. Herein, the silica precursor and titania precursor are independently vaporized (evaporated) depending on the vaporization temperature of each precursor, and then conveyed and supplied to the reaction unit 300. Particularly, as shown in FIG. 1, the precursor supplying units 100, 100′ comprise a silica precursor supplying unit 100 and a titania precursor supplying unit 100′ in such a manner that each precursor is vaporized (evaporated) and supplied independently.

According to another embodiment, the vaporizates of silica precursor and titania precursor may be forced to be conveyed and supplied through a carrier member. For example, the carrier member may be selected from a carrier gas, pump and blower fan. More particularly, a carrier gas may be used advantageously as described hereinafter.

Particularly, according to an exemplary embodiment, the silica precursor supplying unit 100 may comprise a vaporization tank 120 in which the silica precursor is vaporized, a precursor supplying line 140 through which the vaporizate of silica precursor is conveyed and supplied to the reaction unit 300, and a carrier gas supplying line 160 through which a carrier gas is supplied to the vaporization tank 120 as a carrier member.

In addition, the titania precursor supplying unit 100′ may comprise a vaporization tank 120 in which the titania precursor is vaporized, a precursor supplying line 140 through which the vaporized product of titania precursor is conveyed and supplied to the reaction unit 300, and a carrier gas supplying line 160 through which a carrier gas is supplied to the vaporization tank 120 as a carrier member.

Further, the vaporization tank 120 may be provided in various forms. For example, the vaporization tank 120 may comprise a bubbler 122 in which a silica precursor and titania precursor each are received and vaporized, and a heating source 124 applying heat to the bubbler 122.

Herein, the bubbler 122 may have various container shapes, such as a cylindrical or polyprismatic shape. In addition, a plate may be installed inside the bubbler 122, and such a plate may comprise a single layer or two or more layers.

The heating source 124 is not particularly limited, as long as it supplies heat to the bubbler 122. For example, the heating source 124 may be selected from a heating wire or band heater to which electric power is applied to emit heat. The heating source 124, such as a heating wire or band heater, may be installed in such a manner that it is wound around the outer circumference of the wall body of the bubbler 122 or it is embedded inside the bubbler 122.

Particularly, according to an exemplary embodiment, the heating source 124 may comprise an oil bath maintaining high temperature. More particularly, the heating source 124 may comprise an oil bath 124a in which oil is received, and a heating member 124b for heating the oil.

As shown in FIG. 1, a heating wire may be used as the heating member 124b. When using the oil bath 124a containing hot oil as the heating source 124 applying heat to the bubbler 122, it is possible to prevent rapid warming of the bubbler 122 and to supply heat uniformly to the whole regions of the bubbler 122.

The vaporizates of silica precursor and titania precursor generated at the vaporization tank 120 are conveyed and supplied to the reaction unit 300 along the precursor supplying line 140. Herein, according to an exemplary embodiment, the precursor supplying line 140 is connected to the vaporization tank 120 at one side and to the reaction unit 300 at the other side directly or by way of an introduction line 150. More particularly, one side of the precursor supplying line 140 is connected to the bubbler 122 of the vaporization tank 120, and the other side thereof may be coupled to an introduction line 150 connected sealably with the reaction tube 310 of the reaction unit 300 through a coupling member 311 such as a flange.

According to an embodiment, the precursor supplying line 140 may be provided with a constant temperature-maintaining member 142 preventing condensation of the vaporizates of silica precursor and titania precursor. The constant temperature-maintaining member 142 may be one capable of preventing the vaporizates of silica precursor and titania precursor from being condensed while they are conveyed along the supplying line 140.

The constant temperature-maintaining member 142 is a heat-insulating or heating member. For example, the constant temperature-maintaining member 142 may be selected from a heat-insulating material, heating wire or band heater formed on the outer circumference of the precursor supplying line 140. More particularly, the constant temperature-maintaining member 142 may be selected from a heating wire wound on the outer circumference of the precursor supplying line 140.

According to an embodiment, the introduction line 150 may also be provided with a constant temperature-maintaining member 152 preventing condensation of the silica precursor and titania precursor. Such a constant temperature-maintaining member 152 also prevents the vaporizates of silica precursor and titania precursor from being condensed while they are conveyed to the reaction unit 300. As exemplified above, the constant temperature-maintaining member may be selected from a heat-insulating material, heating wire or band heater formed on the outer circumference of the introduction line 150.

In addition, the carrier gas supplying line 160 is for use in supplying a carrier gas to the vaporization tank 120. Herein, the carrier gas serves as a carrier that allows the vaporizates of silica precursor and titania precursor generated at the vaporization tank 120 to be conveyed and supplied easily to the reaction unit 300. Particularly, the vaporizates of silica precursor and titania precursor generated at the vaporization tank 120 are conveyed and supplied to the introduction line 150 along the precursor supplying line 140 by the carrying operation of the carrier gas, and then to the reaction unit 300 along the introduction line 150.

The carrier gas supplying line 160 is not particularly limited, as long as it allows supply of a carrier gas to the vaporization tank 120. For example, the carrier gas supplying line comprises a bombe 162 in which a carrier gas is stored, and a gas supplying line 164 providing a flow path through which the carrier gas stored in the bombe 162 is conveyed and supplied to the vaporization tank 120. Herein, the gas supplying line 164 may be connected to the bombe 162 at one end and is embedded in the bubbler 122 of the vaporization tank 120 at the other end.

The carrier gas is not particularly limited, as long as it is capable of carrying the vaporizates of silica precursor and titania precursor. Although there is no particular limitation, the carrier gas may be any one selected from the group consisting of argon (Ar), nitrogen (N₂), helium (He), oxygen (O₂) and air, or a mixed gas of at least two of them. More particularly, the carrier gas may be argon (Ar).

The carrier gas supplying line 160 may further comprise a mass flow controller (MFC) 165 controlling the injection flux of the carrier gas. As shown in FIG. 1, such a mass flow controller 165 may be provided on the supplying line 164. Herein, the feed flux of the vaporizates of silica precursor and titania precursor supplied to the reaction unit 300 may be controlled by the injection flux of the carrier gas. In a variant, the feed flux of the vaporizates of silica precursor and titania precursor may be controlled by a flux controller (not shown) provided on the precursor supplying line 140.

In addition, the carrier gas may be maintained at an adequate temperature. When the carrier gas is supplied to the vaporization tank 120 at an excessively low temperature, the vaporizate of silica precursor or titania precursor in the vaporization tank 120 may be condensed to produce liquid mist. Therefore, the carrier gas may be maintained approximately at the same temperature as the vaporizates of silica precursor and titania precursor in the vaporization tank 120. For this, the carrier gas supplying line 160 may further comprise a heat insulating member or heating member. For example, such a heat insulating or heating member may be provided on the bombe 162. Particularly, the heat insulating or heating member may be provided on the gas supplying line 164 through which the carrier gas flows. In addition, the heat insulating or heating member may be selected from a heat insulating material, heating wire and band heater. In FIG. 1, a heating wire 166 is formed on the injection line 164 as a heating member.

Further, the precursor supplying units 100, 100′ may further comprise a temperature controller 180. The temperature controller 180 at least controls the heating source 124 of the vaporization tank 120 so that an adequate amount of heat is supplied to the bubbler 122. Herein, the temperature of the heating source 124 controlled by the temperature controller 180 may vary with the particular types of the silica precursor and titania precursor. The temperature of the heating source 124 may be determined by the boiling points of the silica precursor and titania precursor. For example, the temperature may be controlled to 55-65° C. for the silica precursor, and to 80-110° C. for the titania precursor.

In addition, the temperature controller 180 controls not only the temperature of the vaporization tank 120 but also at least one of the temperature of the vaporizates of silica precursor and titania precursor flowing through the precursor supplying line 140 or the temperature of the carrier gas. In other words, the temperature controller 180 may control the temperature of the constant temperature maintaining member 142 installed on the precursor supplying line 140 and/or the temperature of the heating wire 166 formed on the carrier gas supplying line 164.

Herein, the silica precursor is not particularly limited, as long as it is a compound containing silicon (Si) in its molecule. The silica precursor contains at least one silicon (Si) atom in its molecule and may further contain an oxygen atom (O). For example, although there is no particular limitation, the silica precursor may be at least one selected from inorganic silicon compounds and organosilicon compounds. Particular examples of the silica precursor comprise at least one selected from tetraethyl orthosilicate ((C₂H₅O)₄Si), diethoxydimethylsilane ((CH₃)₂Si(OC₂H₅)₂), octamethylcyclotetrasiloxane (Si(CH₃)₂O) or the like.

In addition, the titania precursor is not particularly limited, as long as it is a compound containing titanium (Ti) in its molecule. The titania precursor contains at least titanium (Ti) atom in its molecule and may further contain an oxygen atom (O). For example, although there is no particular limitation, the titania precursor may be at least one selected from inorganic titanium compounds and organotitanium compounds. Particular examples of the inorganic titanium compounds comprise titanium tetrachloride (TiCl₄). Particularly, the titania precursor may be selected from organotitanium compounds, including titanium alkoxides.

More particularly, the titania precursor may be at least one selected from the group consisting of titanium alkoxides, such as titanium tetramethoxide, titanium tetraethoxide, titanium tetra-n-propoxide, titanium tetra-isopropoxide and titanium tetra-n-butoxide. Among those, titanium tetra-isopropoxide (TTIP, Ti[OCH(CH₃)₂]₄) is particularly useful.

The oxygen supplying line 200 is for use in supplying an oxygen source to the reaction unit 300. According to an exemplary embodiment, the oxygen supplying line 200 may comprise a storage tank 210 in which an oxygen source is stored, and an oxygen conveying line 220 through which the oxygen source stored in the storage tank 210 is supplied. Herein, the oxygen conveying line 220 is connected to the storage tank 210 at one side and to the reaction tube 310 of the reaction unit 300 at the other side. Particularly, as shown in FIG. 1, the oxygen conveying line 220 may be connected to the storage tank 210 at one side and connected integrally to the introduction line 150.

In the storage tank 210, at least one oxygen source, such as one selected from oxygen (O₂) and air, may be charged and stored. In addition, the oxygen supplying line 200 may further comprise a mass flow controller (MFC) 205 controlling the feed flux of the oxygen source, and such an MFC 205 may be provided on the oxygen conveying line 220 as shown in FIG. 1.

Further, the oxygen source may be maintained at an adequate temperature. Particularly, when the oxygen source is supplied to the reaction unit 300 at an excessively low temperature, it may cause condensation of the vaporizates of silica precursor and titania precursor generated at the precursor supplying units 100, 100′ upon the contact with the latter. Thus, the oxygen source may be maintained approximately at the same temperature as the vaporizate of each precursor. For this, the oxygen supplying line 200 may further comprise a heat insulating member or heating member. For example, the storage tank 210 may be provided with a heat insulating member or heating member, or the oxygen conveying line 220 may be provided with a heat insulating member or heating member. The heat insulating member or heating member may be selected from a heat insulating material, heating wire and band heater as mentioned above. In FIG. 1, a heating wire 226 formed on the oxygen conveying line 220 is exemplified as a heating member.

The reaction unit 300 generates silica-titania (SiO₂—TiO₂) composite particles from the vaporizates of silica precursor and titania precursor introduced thereto. Particularly, the reaction unit 300 is maintained at high temperature so that silica-titania (SiO₂—TiO₂) particles are produced via chemical vapor synthesis. Herein, the reaction unit 300 comprises a reaction tube 310 in which reaction occurs, and a heat supplying member 320 supplying heat to the reaction tube 310 at high temperature.

The reaction tube 310 has a tubular shape and may comprise a metallic or ceramic material. For example, the reaction tube 310 may comprise a ceramic material selected from an alumina tube, quartz tube and mullite tube.

Although the heat supplying member 320 is not particularly limited, as long as it is one capable of supplying heat to the reaction tube 310 and have various forms. For example, the heat supplying member 320 may comprise a heating wire or band heater emitting heat under the application of electric power. The heat supplying member 320 such as a heating wire or band heater may be formed along the length of the reaction tube 310 singly or in groups. In a variant, the heat supplying member 320 may be wound spirally on the outer circumference of the reaction tube 310.

In addition, as shown in FIG. 1, the heat supplying member 320 may be selected from an externally warmed electric furnace having a heating wire 322 embedded in a thermally conductive coating body 324, and the like. In another variant, the heat supplying member 320 may be a hot fluid flowing through the double jacket-type reaction tube 310. The heat supplying member 320 is not limited to the above-described embodiment, and any heat supplying member capable of supplying heat to the reaction tube 310 may be used.

In addition, the reaction unit 300 may further comprise a temperature controller 350. The temperature controller 350 may control the heat supplying member 320 to adjust the internal temperature of the reaction tube 310 to an adequately high temperature. For example, the internal temperature of the reaction tube 310 may be maintained at 700-1200° C. Further, the reaction tube 310 may be maintained at ambient pressure (atmospheric pressure) or may be present in a vacuum state below ambient pressure by a depressurization chamber (not shown).

The silica-titania (SiO₂—TiO₂) composite particles prepared at the reaction unit 300 are collected and recovered at a recovering unit 400. According to an exemplary embodiment, the silica-titania (SiO₂—TiO₂) composite particles prepared at the reaction tube 310 are introduced to the recovering unit 400 under the carrying operation of the carrier gas and collected/recovered at the recovering unit 400.

According to an embodiment, the recovering unit 400 comprises a cooler 410 in which the silica-titania (SiO₂—TiO₂) composite particles ejected from the reaction unit 300 are cooled and condensed. The recovering unit 400 also comprises a particle collector (not shown) collecting and recovering the cooled and condensed silica-titania (SiO₂—TiO₂) composite particles. Herein, the particle collector is not particularly limited, as long as it is capable of collecting and recovering the silica-titania (SiO₂—TiO₂) composite particles. For example, the particle collector may be selected from a cyclone-type collector, gravity-settling type collector and a filtering type collector.

The cooler 410 cools and condenses the hot product (i.e. fluid containing the silica-titania (SiO₂—TiO₂) composite particles) ejected from the reaction unit 300. The cooler 410 may be coupled with the reaction tube 310 of the reaction unit 300 through a coupling member 311 such as a flange. Herein, the cooler 410 may be connected to the reaction tube 310 of the reaction unit 300 through an ejection line 405.

Particularly, the cooler 410 may comprise a turbulence-forming section 414a, such as a ball-like section. More particularly, when using a cooler 410 that has a general structure, such as an apparatus having a thermophoretic type linear cooling tube, cooling efficiency for the hot fluid containing the silica-titania (SiO₂—TiO₂) composite particles may be lowered and the characteristics of the silica-titania (SiO₂—TiO₂) composite particles may be degraded. Thus, according to an embodiment, a rapid cooler 410 including a turbulence-forming section 414a, such as a ball-like section may be used. In other words, according to an embodiment, the cooler 410 having a turbulence-forming section 414a cools and condenses the silica-titania (SiO₂—TiO₂) composite particles rapidly, thereby improving the properties of the silica-titania (SiO₂—TiO₂) catalyst.

FIG. 2 shows a sectional schematic view of such a rapid cooler 410 according to an embodiment.

Referring to FIG. 2, the rapid cooler 410 has a double tubular shape including an external tube 412 and an internal tube 414 formed inside the external tube 412. In addition, a coolant flow path 411 through which a coolant flows is formed between the internal tube 414 and the external tube 412, and the external tube 412 is provided with a coolant inlet 412a and a coolant outlet 412b.

As shown in FIG. 2, the internal tube 414 comprises a fluid flow path 413 through which a hot fluid (fluid containing hot silica-titania (SiO₂—TiO₂) composite particles) passes, and is provided with a turbulence-forming section 414a against which the fluid bumps to generate turbulence. The turbulence-forming section 414a is any one capable of forming turbulence. For example, it has a ball-like shape as shown in FIG. 2. More particularly, the turbulence-forming section 414a has a ball-like shape with the internal tube 414 protruding out toward the exterior, and may have a circular or elliptic sectional shape. The turbulence-forming section 414a may be formed along the length of the internal tube 414 singly or in groups.

Therefore, the coolant introduced through the coolant inlet 412a flows along the coolant flow path 411 formed between the internal tube 414 and the external tube 412, while it allows cooling and condensation of the hot fluid (silica-titania (SiO₂—TiO₂) composite particles) passing through the fluid flow path 413 of the internal tube 414. In addition, as shown in FIG. 2, the fluid introduced to the fluid flow path 413 naturally has turbulence due to the turbulence-forming section 414a. As a result, the fluid or hot silica-titania (SiO₂—TiO₂) composite particles are cooled rapidly so that their particle characteristics are improved and the condensation recovery ratio is increased.

Herein, there is no particular limitation in the coolant. For example, the coolant may be selected from cooling water, gaseous nitrogen, liquefied nitrogen, gaseous ammonia, liquefied ammonia, or the like.

Particularly, since the fluid introduced to the internal tube 414 has turbulence due to the ball-like turbulence-forming section 414a, it has a long time (i.e. contact time with the coolant) to be in contact with the wall surface of the internal tube 414. In addition, the introduced fluid is in contact with the coolant over a large surface area due to the turbulence-forming section 414a. In other words, the turbulence-forming section 414a has a ball-like shape as shown in FIG. 2, and thus causes an increase in contact area between the fluid (silica-titania (SiO₂—TiO₂) composite particles) and the coolant. As a result, the hot silica-titania (SiO₂—TiO₂) composite particles are cooled rapidly in a short time to increase the condensation recovery ratio, while improving the particle characteristics, such as specific surface area and pore volume by virtue of such rapid cooling and condensation.

The recovering unit 400 may comprise one or two or more such rapid coolers 410. In other words, a single rapid cooler 410 or two or more such rapid coolers connected in series may be used to facilitate cooling. In addition, there is no limitation in length of the rapid cooler 410. And, a particle collector may be linked to the rear end of the rapid cooler 410.

The method for preparing a silica-titania (SiO₂—TiO₂) catalyst will now be described.

The method for preparing a silica-titania (SiO₂—TiO₂) catalyst disclosed herein comprises: vaporizing a silica precursor and titania precursor; conveying vaporizates of the silica precursor and titania precursor to a reaction unit; reacting the vaporizates with an oxygen supplying source to form silica-titania particles; and recovering the silica-titania catalyst. The above-mentioned operations are carried out continuously. As described above, the preparation of silica-titania (SiO₂—TiO₂) catalyst may be carried out in the apparatus as described hereinbefore. The method will be described in more detail hereinafter.

Vaporization

First, a silica precursor and titania precursor are vaporized (allowed to evaporate) to produce vaporizates. The vaporization may be performed at the precursor supplying units 100, 100′ of the above-described apparatus.

As used herein, vaporization (evaporation) does not mean merely a thermal conversion from a liquid (solid) titania precursor into a complete gas state but also comprises atomization to an effervescent state.

In addition, particular examples of the silica precursor and titania precursor are the same as described above. In the vaporizing operation according to an embodiment, the silica precursor and titania precursor are vaporized (or atomized) into a vapor phase so as to obtain high reactivity in the reaction unit 300. Herein, when each precursor is not vaporized (or atomized) but supplied to the hot reaction unit 300 in a liquid phase, the yield (productivity) of silica-titania (SiO₂—TiO₂) particles in the reaction unit 300 may be lowered and the particle characteristics (particle size and dispersibility) may be degraded.

The vaporization operation may be carried out by heating the precursors to an adequate temperature depending on the particular types and amounts of the silica precursor and titania precursor. Although there is no particular limitation, the silica precursor may be vaporized (or atomized) by heating it to a temperature of 55-65° C. For example, when using an organic compound, such as titanium alkoxide, as a titania precursor, vaporization may be carried out at a temperature of 80-110° C. by heating considering the boiling point of the compound. More particularly, vaporization may be carried out by maintaining the temperature of the bubbler 122 of the precursor supplying units 100, 100′ to the above temperature range. When the temperature is excessively low, the vaporized product is generated at a low concentration, resulting in a drop in productivity (yield) of the silica-titania (SiO₂—TiO₂) particles. On the other hand, when the temperature is excessively high, the vaporizates are generated at a high concentration, resulting in degradation of particle characteristics (e.g. formation of unwanted large silica-titania (SiO₂—TiO₂) particles).

Conveying Reactants

The vaporizates of the silica precursor and titania precursor are conveyed to the reaction unit 300. Herein, the vaporizates of the silica precursor and titania precursor may be conveyed and supplied to the reaction unit 300 along with a carrier gas. The carrier gas serves as a carrier as mentioned above and may be supplied through the carrier gas supplying line 160.

In addition, an oxygen source is further supplied to the reaction unit 300. The oxygen source may be selected from oxygen, air, etc., and may be supplied through the oxygen supplying line 200 as described above.

Reaction

Then, silica-titania (SiO₂—TiO₂) composite particles are produced from the vaporizates of silica precursor and titania precursor by reacting an oxygen source (oxygen, air, etc.). Particularly, the vaporizates of silica precursor and titania precursor and an oxygen source are supplied to the reaction unit 300 and allowed to react with each other at an adequate temperature to produce silica-titania (SiO₂—TiO₂) particles.

Herein, the oxygen source serves as a source of oxygen for producing silica-titania (SiO₂—TiO₂) composite particles, as well as functions to protect the vaporizate of each precursor from the ingredients (e.g. reaction gas introduced from the exterior, or the like) that may adversely affect the production of particles during the passage through the reaction tube 310. In addition, when a gas, such as pressurized gas, is used as an oxygen source, it may also serve as a carrier for the vaporizate of each precursor.

The reaction temperature may depend on the particular type of each precursor. For example, the reaction temperature may be 700-1200° C. When the reaction temperature is lower than 700° C., it is difficult to perform thermal decomposition of each precursor and sufficient crystallization (formation) of silica-titania (SiO₂—TiO₂) particles, resulting in a drop in yield (productivity). When the reaction temperature is higher than 1200° C., the resultant particles may become crude and undergo a transition from anantase to rutile. Considering these, the reaction temperature may be 800° C. or higher, and particularly 800-1100° C.

Recovering

Then, the silica-titania (SiO₂—TiO₂) particles obtained from the reaction operation are recovered. Herein, the recovering operation comprises cooling and condensing the silica-titania (SiO₂—TiO₂) particles obtained from the reaction operation, and collecting the cooled and condensed silica-titania (SiO₂—TiO₂) particles.

Herein, the condensation operation may be carried out by cooling using a rapid cooler 410 having a turbulence-forming section 414a provided on the flow path 413 of the silica-titania (SiO₂—TiO₂) particles as described earlier.

Particularly, the product (fluid) ejected from the reaction unit 300 contains, in addition to the silica-titania (SiO₂—TiO₂) particles as a target product, a hot gas (carrier gas or the like) and vaporous materials, such as vaporous organic materials generated by thermal decomposition of each precursor, and maintains high temperature. For the purpose of separation and removal of such vaporous materials, the recovering operation comprises cooling and condensing the product obtained from the reaction.

Herein, the cooling operation may be carried out by using the above-mentioned cooler 410, i.e. the rapid cooler 410 described hereinabove with reference to FIG. 2. In other words, the above-described rapid cooler 410 having a turbulence-forming section 414a formed on the fluid flow path 413 is used to carry out the cooling and condensation operation. In addition, the recovering operation may further comprise collecting the cooled and condensed silica-titania (SiO₂—TiO₂) particles. Herein, the collecting operation may be carried out by using a particle collector selected from a cyclone-type collector, gravity-settling type collector and a filtering type collector, as described above.

The silica-titania (SiO₂—TiO₂) catalyst obtained in the above-described manner are those prepared via chemical vapor synthesis including vaporizing a titania precursor, and are condensed by rapid cooling. Thus, it is possible to obtain a silica-titania (SiO₂—TiO₂) catalyst having a high specific surface area and an ultrafine nano-scale uniform particle size by a simple process with ease.

Particularly, the method disclosed herein comprises a continuous process carried out in a short time to allow mass production. As described above, the method provides a high collection yield (recovery ratio after condensation) of catalyst by virtue of rapid cooling (condensation). In addition, it is possible to obtain a silica-titania (SiO₂—TiO₂) catalyst having a high specific surface area, an increased pore volume and excellent catalytic activity with ease. Further, it is possible to obtain a silica-titania (SiO₂—TiO₂) catalyst having excellent thermal stability and undergoing no phase transition even in a high-temperature region.

The examples and comparative examples will now be described. The following examples are for illustrative purposes only and not intended to limit the scope of the present disclosure.

### Example 1

### Preparation of Silica-Titania (SiO₂—TiO₂) Catalyst

Silica-Titania (SiO₂—TiO₂) catalyst particles are prepared by using the apparatus as shown in FIG. 1.

First, tetraethyl orthosilicate (TEOS, (C₂H₅O)₄Si) as a silica precursor is introduced to the bubbler 122 of the silica precursor supplying unit 100, and maintained at 60° C. by external warming. In addition, titanium tetraisoproxide (TTIP, Ti[OCH(CH₃)₂]₄) is introduced as a titania precursor to the bubbler 122′ of the titania precursor supplying unit 100′, and maintained at 95° C. by external warming. Herein, Ar gas is injected into the TEOS (silica precursor) supplying unit 100 and into the TTIP (titania precursor) supplying unit 100′ at a flow rate of 0.7 L/min to allow each precursor to evaporate, and then conveyed to the reaction unit 300 through which 7 L/min of air flows.

Then, the reaction tube 310 of the reaction unit 300 is maintained at 900° C. by using an externally warmed electric furnace to produce SiO₂—TiO₂ catalyst particles. After that, the fluid containing the hot SiO₂—TiO₂ catalyst particles produced from the reaction tube 310 are passed through the rapid cooler 410 to condense and collect the SiO₂—TiO₂ catalyst particles.

Herein, cooling water is used as coolant in the rapid cooler 410 so that the temperature is maintained at 10° C.

### Example 2

### Preparation of SiO₂—TiO₂ Catalyst (Thermal Stability)

Example 1 is repeated, except that heat treatment is further carried out at 900° C. to determine the thermal stability of the SiO₂—TiO₂ catalyst. Particularly, SiO₂—TiO₂ catalyst particles are prepared and collected in the same manner as Example 1, and then the collected SiO₂—TiO₂ catalyst particles are further heat treated at 900° C. for 1 hour.

### Comparative Example 1

### Preparation of TiO₂ Catalyst

Example 1 is repeated to prepare and collect a TiO₂ catalyst, except that tetraethyl orthosilicate (TEOS) as a silica precursor is not introduced. Particularly, a TiO₂ catalyst particles are prepared and collected in the same manner as described in Example 1, except that argon (Ar) gas is not introduced to the silica precursor supplying unit 100 of the apparatus as shown in FIG. 1.

### Comparative Example 2

### Preparation of TiO₂ Catalyst (Thermal Stability)

Comparative Example 1 is repeated, except that heat treatment is further carried out at 900° C. to determine the thermal stability of the TiO₂ catalyst. Particularly, TiO₂ catalyst particles are prepared and collected in the same manner as Comparative Example 1, and then the collected TiO₂ catalyst particles are further heat treated at 900° C. for 1 hour.

### Test Example 1

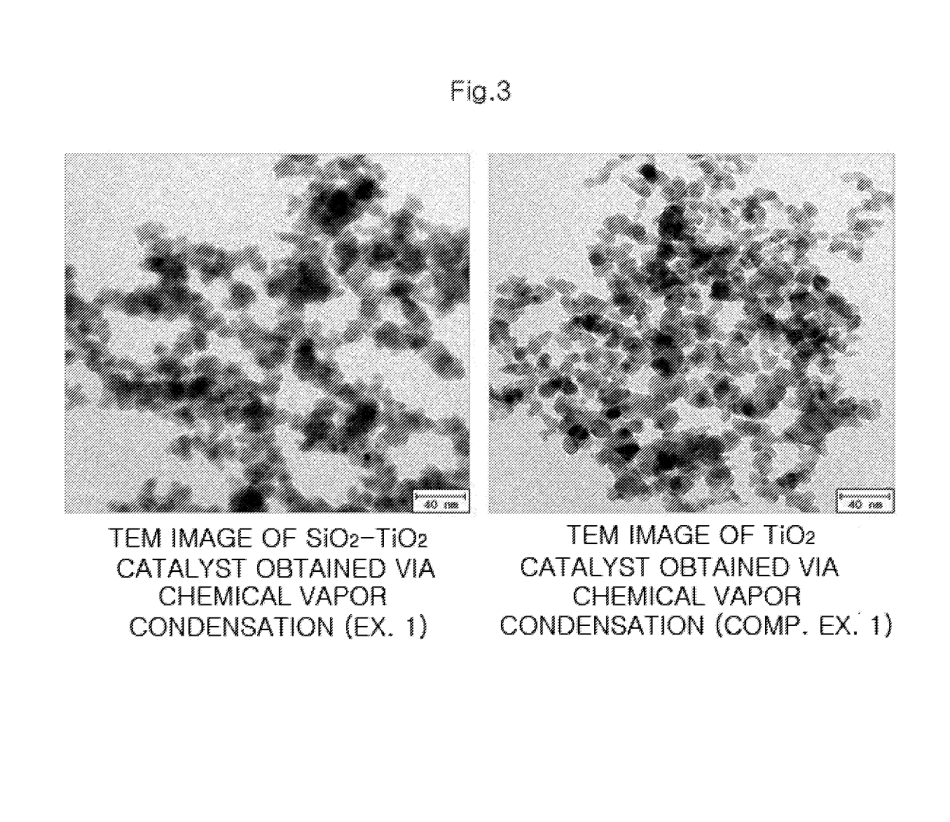

The transmission electron microscopic (TEM) images of the SiO₂—TiO₂ catalyst (Example 1) obtained via chemical vapor condensation and the TiO₂ catalyst (Comparative Example 1) are shown in FIG. 3.

As shown in FIG. 3, the SiO₂—TiO₂ catalyst (Example 1) and the TiO₂ catalyst (Comparative Example 1) have a primary particle size of 20 nm or less. In other words, both catalysts have a very small particle size in the form of a bunch of closely packed grapes and show a uniform particle size distribution. This suggests that addition of silica (SiO₂) does not affect the primary particle size substantially.

### Test Example 2

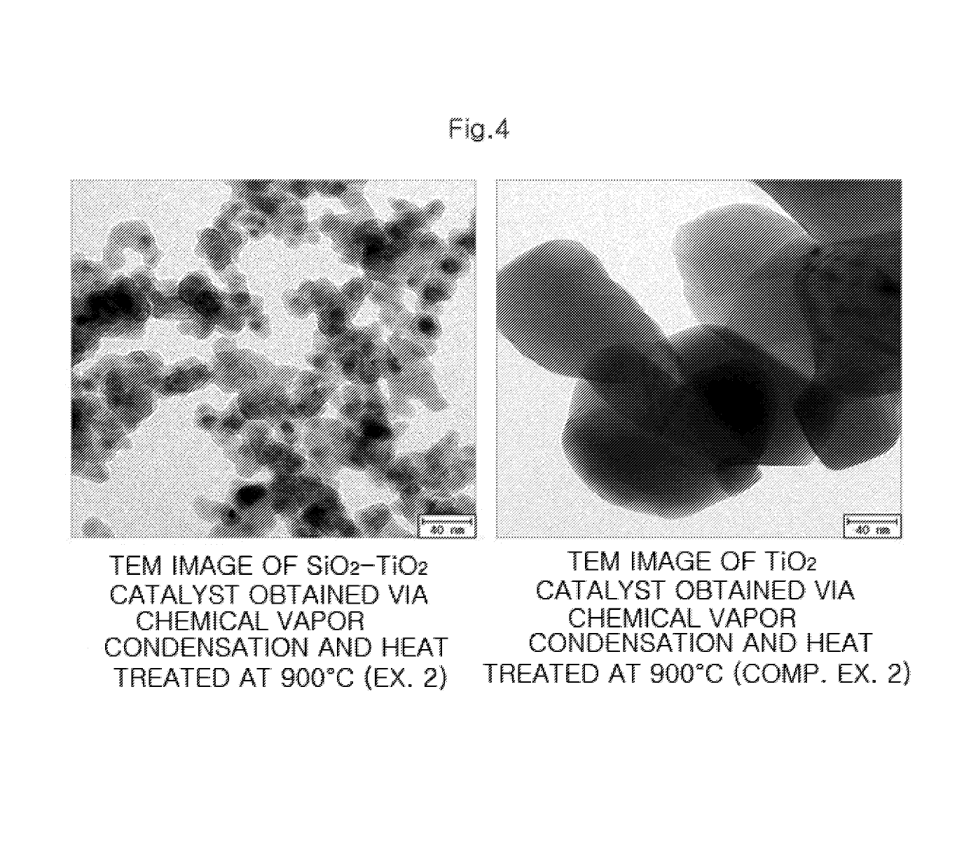

The TEM images of the SiO₂—TiO₂ catalyst (Example 2) and TiO₂ catalyst (Comparative Example 2) obtained via chemical vapor condensation and heat treated at 900° C. for 1 hour are shown in FIG. 4.

As shown in FIG. 4, the TiO₂ catalyst (Comparative Example 2) heat treated at 900° C. undergoes sintering of particles, resulting in an increase in particle size. On the contrary, the SiO₂—TiO₂ catalyst (Example 2) heat treated at 900° C. shows local sintering but undergoes substantially no change, and thus maintains it original particle shape before heat treatment. This suggests that addition of silica (SiO₂) provides high thermal stability so that sintering of the catalyst particles is inhibited.

### Test Example 3

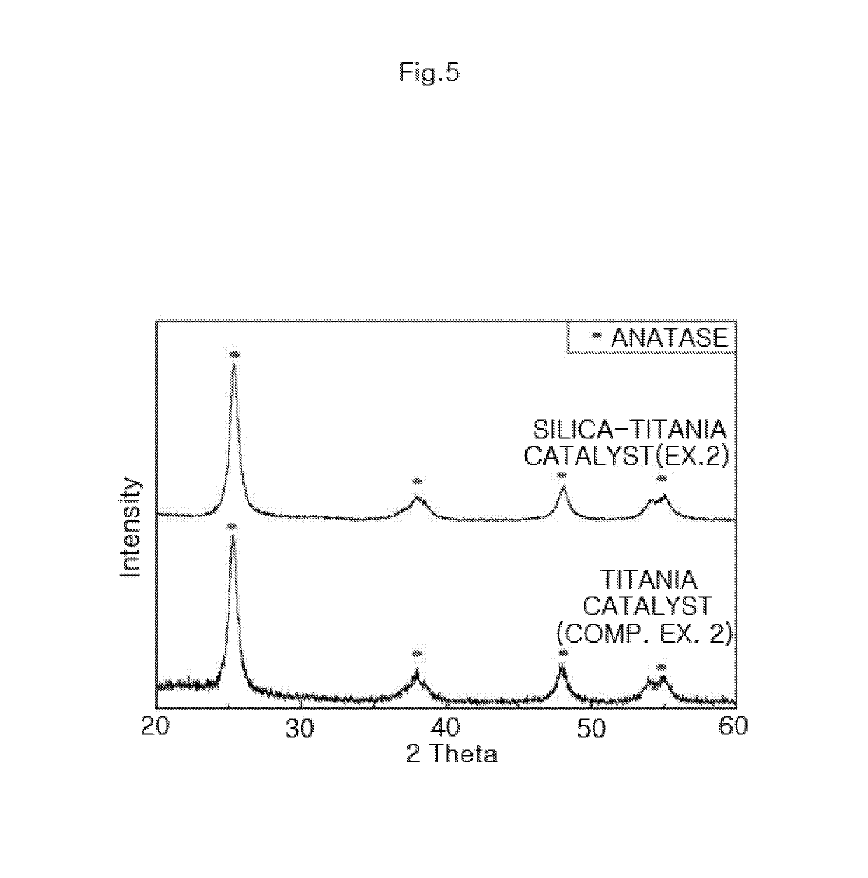

The images of X-ray diffractometry (XRD) of the SiO₂—TiO₂ catalyst (Example 1) and TiO₂ catalyst (Comparative Example 1) are shown in FIG. 5.

In general, in the case of anatase, its main peak is observed at 2θ of 25.4°. However, in the case of rutile, its main peak is observed at 27.5°. As shown in FIG. 5, both the SiO₂—TiO₂ catalyst (Example 1) and TiO₂ catalyst (Comparative Example 1)° have a main peak at 2θ of 25.4°, suggesting that they show an anatase crystal phase.

### Test Example 4

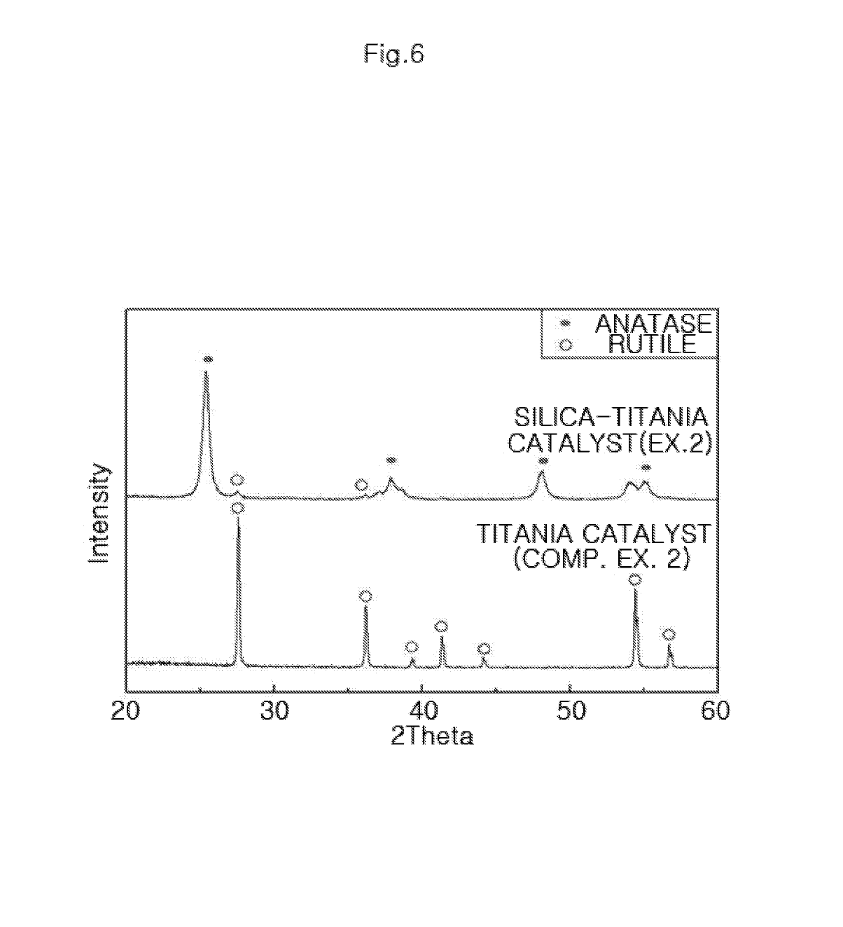

The images of XRD of the SiO₂—TiO₂ catalyst (Example 2) and TiO₂ catalyst (Comparative Example 2) obtained via chemical vapor condensation and then heat treated at 900° C. for 1 hour are shown in FIG. 6.

As shown in FIG. 6, the heat treated TiO₂ catalyst (Comparative Example 2) undergoes a phase transition from anatase to rutile. On the contrary, even after heat treatment, the SiO₂—TiO₂ catalyst (Example 2) still has anatase crystals. This demonstrates that addition of silica (SiO₂) provides titania (TiO₂) particles with improved thermal stability, so that the resultant catalyst maintains an anatase phase even at high heat treatment temperature.

### Test Example 5

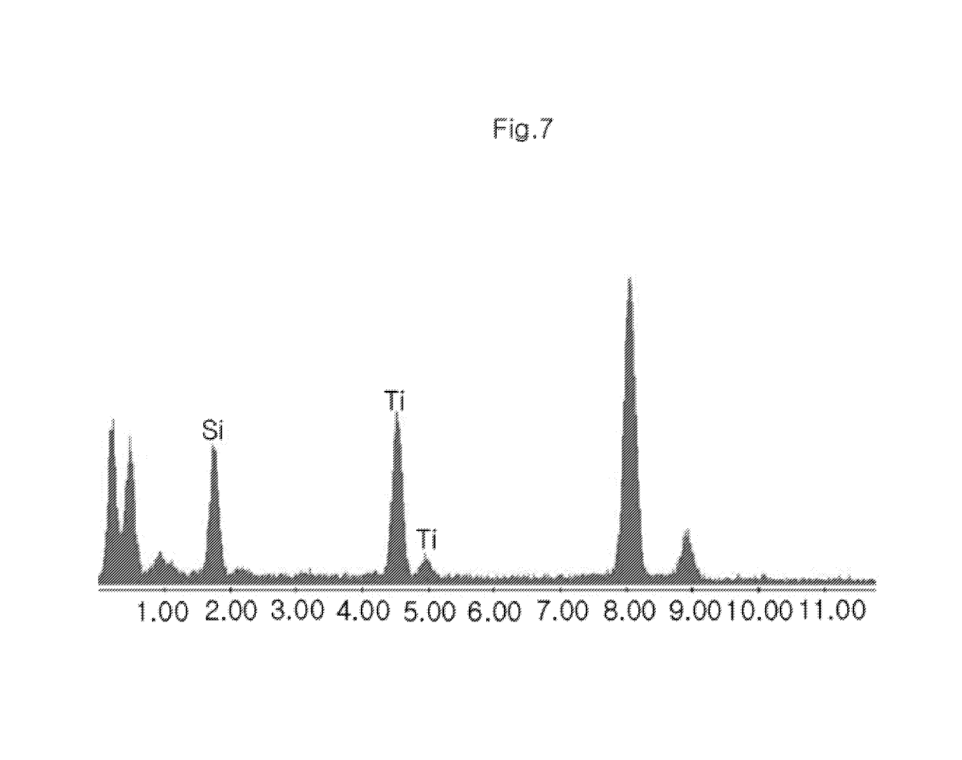

The results of qualitative elemental analysis based on energy dispersive spectroscopy (EDS) of the SiO₂—TiO₂ catalyst (Example 1) obtained via chemical vapor condensation are shown in FIG. 7.

As shown in FIG. 7, after carrying out elemental analysis, the catalyst comprises silica and titania.

### Test Example 6

The catalysts according to Examples 1 and 2 and Comparative Examples 1 and 2 are evaluated in terms of their specific surface areas based on the Brunauer-Emmett-Teller (BET) method measuring nitrogen adsorption amount at 77K, average particle sizes and anatase crystal ratios. The results are shown in the following Table 1.

TABLE 1
<Results of Characterization of Catalysts>

| | Heat | | | |
|---|---|---|---|---|
| | treatment | | Average | |
| | temperature | BET surface | particle | Anatase |
| | (° C.) | area (m²/g) | size (nm) | ratio (%) |
| Ex. 1 | — | 75.1734 | 20.4 | 97.6 |
| (SiO₂—TiO₂ | | | | |
| catalyst) | | | | |
| Ex. 2 | 900 | 70.8422 | 21.7 | 95 |
| (SiO₂—TiO₂ | | | | |
| catalyst) | | | | |
| Comp. Ex. 1 | — | 95.8043 | 16.0 | 94.8 |
| (TiO₂ catalyst) | | | | |
| Comp. Ex. 2 | 900 | 4.4026 | 319.5 | 2.2 |
| (TiO₂ catalyst) | | | | |

As shown in Table 1, the TiO₂ catalyst (Comparative Example 1) obtained via chemical vapor condensation has a particle size of about 16 nm, while the SiO₂—TiO₂ catalyst (Example 1) has a particle size of about 20 nm. Referring to anatase ratios, both the SiO₂—TiO₂ catalyst (Example 1) and TiO₂ catalyst (Comparative Example 1) have an anatase crystal ratio of 90% or higher.

In addition, in the case of the catalysts heat treated at 900° C. for 1 hour to evaluate the thermal stability of a catalyst obtained via chemical vapor condensation, the pure TiO₂ catalyst (Comparative Example 2) undergoes a rapid increase in particle size to about 320 nm. On the contrary, the SiO₂—TiO₂ catalyst (Example 2) has a particle size of about 22 nm and thus shows little change in particle size even after heat treatment. It is thought that this is because silica (SiO₂) dispersed homogeneously throughout the catalyst even after heat treatment inhibits movement of titania (TiO₂) catalyst and molecules, thereby preventing agglomeration of titania (TiO₂) and an increase in catalyst particle size.

Further, referring to the anatase crystal ratios after heat treatment, it can be seen that the TiO₂ catalyst (Comparative Example 2) undergoes a phase transition from anatase to rutile, and thus the TiO₂ catalyst has the anatase crystal ratios of 2.2%. On the contrary, the SiO₂—TiO₂ catalyst (Example 2) has an anatase crystal ratio of 95%, suggesting that substantially no phase transition occurs. This suggests that a phase transition from anatase to rutile is inhibited in the SiO₂—TiO₂ catalyst applied to a high temperature region. This demonstrates that the SiO₂—TiO₂ catalyst disclosed herein has excellent thermal stability, and thus may be useful as a high-activity photocatalyst at high temperature.

While the exemplary embodiments have been shown and described, it will be understood by those skilled in the art that various changes in form and details may be made thereto without departing from the spirit and scope of the present disclosure as defined by the appended claims.

What is claimed is:

1. An apparatus for preparing a silica-titania catalyst, comprising:
precursor supplying units;
an oxygen supplying line;
a reaction unit; and
a recovering unit,
wherein the precursor supplying units vaporize a silica precursor and titania precursor and supply them to the reaction unit,
wherein the oxygen supplying line supplies an oxygen source to the reaction unit,
wherein the reaction unit converts vaporizates of the silica precursor and titania precursor supplied from the precursor supplying units to produce a silica-titania catalyst,
wherein the recovering unit cools, condenses and collects the silica-titania catalyst produced at the reaction unit,
wherein the recovering unit comprises a cooler for cooling the silica-titania catalyst introduced from the reaction unit, and the cooler comprises a turbulence-forming section on a flow path of the silica-titania catalyst.

2. The apparatus for preparing a silica-titania catalyst according to claim 1, wherein the cooler comprises an external tube and an internal tube formed in the external tube, a coolant flow path is formed between the internal tube and the external tube, the internal tube comprises a flow path through which the silica-titania catalyst passes, and the flow path comprises a turbulence-forming section against which the silica-titania catalyst introduced to the flow path bumps to form turbulence.

3. The apparatus for preparing a silica-titania catalyst according to claim 1, wherein the precursor supplying units comprise a silica precursor supplying unit and a titania precursor supplying unit, and each of the silica precursor supplying unit and the titania precursor supplying unit comprises:
a vaporization tank in which each precursor is heated and vaporized;
a precursor supplying line through which the precursor vaporized at the vaporization tank is conveyed and supplied to the reaction unit; and
a carrier gas supplying line through which a carrier gas is supplied to the vaporization tank.

4. The apparatus for preparing a silica-titania catalyst according to claim 3, wherein the vaporization tank comprises a bubbler in which the precursors are received and vaporized, and an oil bath applying heat to the bubbler.

5. The apparatus for preparing a silica-titania catalyst according to claim 3, wherein the precursor supplying line is provided with a constant temperature-maintaining member preventing the condensation of the precursors.

6. A method for preparing a silica-titania catalyst, comprising:
vaporizing a silica precursor and titania precursor;
conveying vaporizates of the silica precursor and titania precursor to a reaction unit together with an oxygen supplying source;
producing a silica-titania catalyst from the vaporizates of the silica precursor and titania precursor; and
recovering the silica-titania catalyst by cooling, condensing and collecting the silica-titania catalyst,
wherein said condensing is carried out by cooling and condensing the silica-titania catalyst by using a cooler having a turbulence-forming section on a flow path of the silica-titania catalyst.

7. The method for preparing a silica-titania catalyst according to claim 6, which uses the apparatus as defined in claim 1.

8. The method for preparing a silica-titania catalyst according to claim 6, wherein said reacting is carried out by maintaining the reaction unit at a temperature of 700-1200° C.
